(19) United States
(12) Patent Application Publication
(10) Pub. No.: US 2026/0147320 A1
(43) Pub. Date: May 28, 2026

(54) MANUFACTURING SYSTEM INCLUDING A MACHINE LEARNING FEEDBACK LOOP

(71) Applicant: PepsiCo Inc., Purchase, NY (US)

(72) Inventors: Karthik Vuduturi, Mississauga (CA); Aditya Verma, Kokapet (IN); Magesh Bagavathi, Plano, TX (US); Nachiket Karajagi, Plano, TX (US); Sagar Paliwal, Kokapet (IN)

(21) Appl. No.: 19/063,782

(22) Filed: Feb. 26, 2025

(30) Foreign Application Priority Data
Nov. 28, 2024 (IN) 202411093096

(51) Int. Cl. G05B 13/02

(52) U.S. Cl. CPC G05B 13/0265

(57) ABSTRACT

Systems and methods analyze data received from assets in a manufacturing environment, determine a first parameter is over or under a first predetermined threshold for an asset using a first machine learning model deployed on the manufacturing system, and generate an updated parameter value to adjust the asset. The systems and methods analyze a subset of sensor data in the manufacturing system using the first machine learning model, determine an actual accuracy rate of the first machine learning model based on an output by the first machine learning model from analysis of the subset of the sensor data, and based on determining that the actual accuracy rate is below a predefined threshold corresponding to a deployed accuracy rate, trigger a retraining of the first machine learning model using at least the subset of sensor data in the camera feed as training data.

### CLAIM OF PRIORITY

This Application claims the benefit of priority of Indian Provisional Application Number 202411093096, filed Nov. 28, 2024, which is hereby incorporated by reference in its entirety.

### BACKGROUND

In a manufacturing environment there are typically many machines including robotic equipment, processing equipment, packaging equipment, weighers, cameras, and other computing devices that are used to produce products or services. For example, a manufacturing and food processing environment can be used to produce potato chips and have various machines and/or machine components for sorting potatoes, washing potatoes, peeling potatoes, slicing potatoes, seasoning potatoes, and bagging potatoes. As another example, a manufacturing and beverage processing environment can have various machines used to bottle beverages including a storage tank, bottle conveyors, a food product sterilizer, a bottle sterilizer, and a bottle capping component. Each machine can have numerous sensors that can be used to observe progress and issues in the manufacturing process.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIGS. 1A and 1B is a diagrammatic representation of a networked environment in which the present disclosure can be deployed, according to some examples.

FIG. 2 is a flow chart illustrating aspects of a method, according to some examples.

FIG. 3 is a diagrammatic representation of a machine in the form of a computer system within which a set of instructions may be executed to cause the machine to perform any one or more of the methodologies discussed herein, according to some examples.

FIG. 4 is a block diagram showing a software architecture within which examples may be implemented.

FIG. 5 is an example user interface, according to some examples.

### DETAILED DESCRIPTION

As mentioned above, a conventional manufacturing environment can comprise many assets such as robotic equipment, processing equipment, packaging equipment, weighers, cameras, and other computing devices to manufacture products or services. Each of these assets can have numerous sensors that can be used to observe progress and issues in the manufacturing process and thus, these sensors can number in the hundreds or even thousands. For example, a conveyor can be used as an infeed to a beverage manufacturing environment and also comprise one or more robotic arms. The conveyor alone can have sensors to monitor speed, sensors to monitor belt alignment, sensors to monitor weight or pressure, sensors to monitor system health, camera sensors for object detection, and so forth. A robotic arm can also have multiple sensors such force/torque sensors, vison sensors (cameras), proximity sensors, inertial sensors, tactile sensors, and so forth. It is difficult to monitor such a large number of assets individually and manually, and thus, manufacturing lines often need to be stopped entirely to address various issues or changes in conditions during production which reduces the efficiency of the system and creates wasted resources.

A manufacturing system is described herein that utilizes a universal edge system to ensure that all assets in the manufacturing system can be monitored and any issues can be addressed in real time or near real time from detection. The manufacturing system can also ensure that system performance is optimized based on a number of factors, products or desired circumstances. The manufacturing system further comprises a machine learning model feedback loop to ensure that a machine learning model continues to perform at an acceptable level by regularly assessing each machine learning model in the manufacturing system and providing specific data for retraining where a machine learning model drops below a desired accuracy level. For example, real time and/or historic data can be used by the machine learning feedback loop to optimize machine learning models used in manufacturing environments, such as manufacturing environments for producing food or beverage products. The manufacturing system can comprise a plurality of machine learning models.

Some examples of system performance optimization realized using the manufacturing system include maximizing energy efficiency, reducing water consumption, and reducing food product waste to minimize detrimental environmental impact and consumer cost increases, among other things. The manufacturing system can also optimize parameters in light of local ordinances, regulations, and environmental standards.

In some examples, a computing system receives data in real time from a plurality of assets in a manufacturing system, analyzes the data as it is received to determine whether any of the data indicates a value over or under a threshold value for a given parameter, and based on determining that data for a first parameter comprises a parameter over or under a first predetermined threshold for an asset, generates an updated parameter value to adjust the asset. In some examples, determining that the data for the first parameter comprises a parameter over or under a first predetermined threshold for an asset is performed by a first machine learning model deployed on the manufacturing system. The computing system causes the asset associated with the data for the first parameter to be automatically updated with the updated parameter value.

The computing system further analyzes a subset of a plurality of frames in a camera feed from a camera and/or other sensor data in the manufacturing system using the first machine learning model deployed on the manufacturing system. The first machine learning model is associated with a deployed accuracy rate. The computing system determines an actual accuracy rate of the first machine learning model based on an output by the first machine learning model from analysis of the subset of the plurality of frames in the camera feed and/or other sensor data and determines whether the actual accuracy rate is below a predefined threshold corresponding to the deployed or desired accuracy rate. Based on determining that the actual accuracy rate is below the predefined threshold corresponding to the deployed or desired accuracy rate, the computing system triggers a retraining of the first machine learning model using at least the subset of the plurality of frames in the camera feed and/or other sensor data as training data.

### Networked Computing Environment

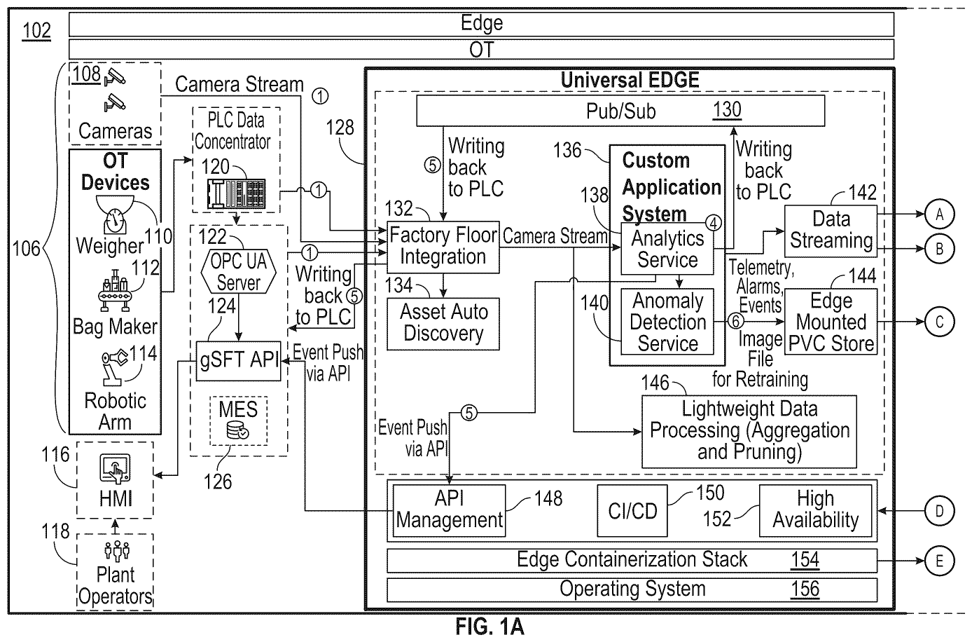

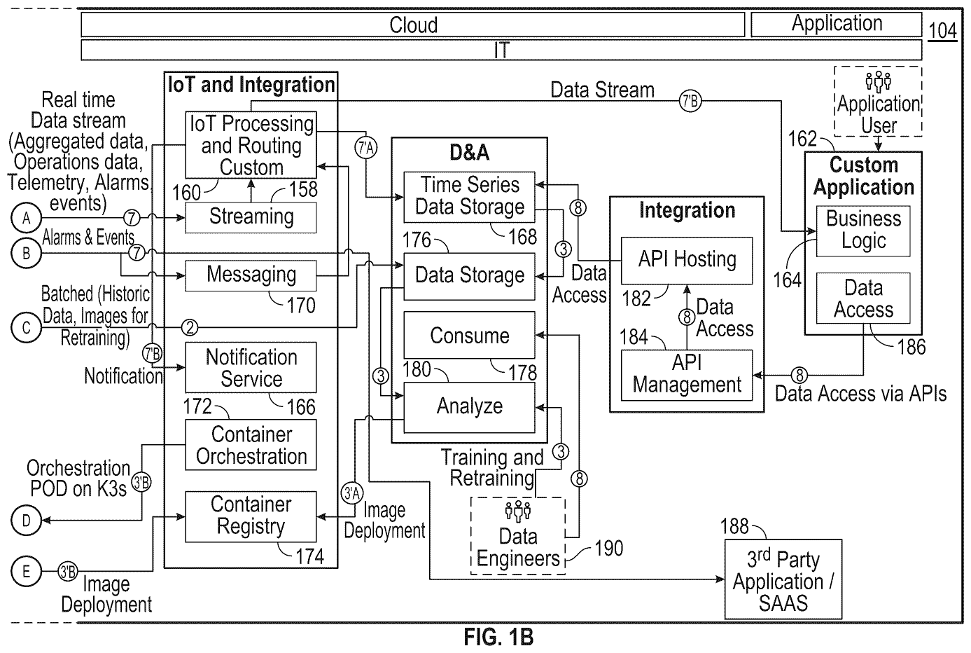

FIGS. 1A and 1B comprise a block diagram (split in two for readability) showing an example networked computing environment 100 for facilitating a manufacturing process, over a network, in a manufacturing environment. FIG. 1A is a part of the block diagram showing a manufacturing system 102 of the networked computing environment 100 and FIG. 1B is a part of the block diagram showing a cloud computing system 104 of the networked computing environment 100. Each component in the networked computing environment 100 is communicatively connected via one or more communication networks to exchange data and messages.

The manufacturing system 102 shown in FIG. 1A can be a computing system located in a manufacturing warehouse or other manufacturing environment and comprises a number of assets 106. These assets 106 can include one or more devices, such as one or more cameras 108, a weigher 110, a bag maker 112, a robotic arm, or other assets 106. It is to be understood and any given manufacturing system 102 can include more, less, or different assets than what is shown in FIG. 1A. As mentioned above, each of these assets comprises numerous sensors.

In addition to the example sensors mentioned above, example sensors can include sensors from cameras in an entrance or parking lot of the manufacturing environment to track vehicles coming in and out and ensure authorized vehicles are on schedule. Example sensors can further include sensors on a warehouse or factory floor to detect whether employees are wearing personal protective equipment and location of employees to ensure safety, to ensure no unauthorized access, to protect trade secrets and other intellectual property, and to ensure employees not working too many consecutive hours, among other things. Other examples include sensors to monitor, log, and optimize forklift traffic to make sure operators are not driving too fast and issue any warning as needed.

The manufacturing system 102, can further include one or more graphical user interfaces, such as a human machine interface (HMI) 116, that can be used by users 118 such as plant operators or other users to monitor and control the assets 106 and other devices in the manufacturing system 102.

The manufacturing system 102 comprises a programmable logic controller (PLC) data concentrator 120 that manages the assets 106 and other devices, an open platform communications unified architecture (OPC UA) server 122 that is a machine-to-machine communication protocol, and a gSFT API 124 that is able to cause display of an event or other data on an HMI 116 that has access to a manufacturing execution system (MES) 126.

The manufacturing system 102 further comprises a universal edge system 128 that comprises various components such as those shown in FIG. 1A. The universal edge system 128 can provide server-side functionality via a network to these various components and to the cloud computing system 104. The universal edge system 128 provides various services and operations that are provided to various components within the manufacturing system 104 and to the cloud computing system 104. Such operations include transmitting data to, receiving data from, and processing data generated by one or more assets 106, the cloud computing system 104 or other components within the manufacturing system 104. This data can include sensor data, images, video, messages, and other data.

The universal edge system 128 comprises a Publication and Subscription (Pub/Sub) component 130 for publishing data and subscribing to events and data. The Pub/Sub component 130 maintains the order of events so that they stay in the correct chronological order. Along with the chronological order, the Pub/Sub component 130 also allows multiple consumers or applications consume the same data which is published once and subscribed multiple times to save the compute. For example, a message (e.g., alert) can be simultaneously sent to the HMI 116 for an operator visibility, the OPC UA server 122 to actuate a sensor, a digital twin to maintain the state, and via text or email to alert the operator or supervisor.

The universal edge system 128 further comprises a factory floor integration engine 132 for receiving data from the assets 106 and other devices and an asset auto discovery component 134 for scanning the assets 106 to determine any new assets 106 or new sensors that have been added to the manufacturing system 102. This auto discovery makes the universal edge system 128 more adaptable across all platforms and enables data that can be universally annotated to be used across an enterprise.

The universal edge system 128 further comprises a custom application system 136 that comprises an analytics service 138 and an anomaly detection service 140. The custom application system 136 can include various applications, machine learning models, or other tools for analyzing data, via the analytics service 138, that is received from the assets 106 and other devices in the manufacturing system 102 to detect if any data triggers any rules or anomalies, via the anomaly detection service 140, for which an alert needs to be generated. The applications, machines learning models, or other tools can be provided for various technical and business use cases in the manufacturing system 102 via the custom application system 136. The universal edge system 128 can interface with any application.

The universal edge system 128 further comprises a data streaming service component 142 and an edge mounted persistent volume container (PVC) store 144 to send data to the cloud computing system 104 and a lightweight data processing component 146 for aggregation and pruning of data.

The universal edge system 128 also comprises API management 148, continuous integration and continuous delivery or deployment (CI/CD) 150 to continuously deliver machine learning models to the universal edge system 128, and high availability 152 that can replicate data, workloads, and/or models that are business critical across different nodes to ensure the data is available across different nodes regardless of whether one or more nodes becomes disabled.

The universal edge system 128 further comprises an edge containerization stack 154 and an operating system 156, such as Linux or another operating system.

The assets 106, such as the operational technology (OT) devices can continuously, in real-time, send data (e.g., sensor data) to the PLC data concentrator 120 which sends the data to the factory floor integration engine 132. The cameras 108 can also each send data as a camera stream, continuously, in real-time, to the factory floor integration engine 132. For instance, data from field sensors and devices (e.g., assets 106) are transmitted to the factory floor integration engine 132 integration engine of the universal edge system 128 through PLC data concentrator 120 and OPC UA server 122. As per the ISA 95 standards, the pattern can be to extract data from the OPC UA server 122 rather than integrating with the PLC data concentrator 120 directly. A camera stream (e.g., RTSP stream data) from each of one or more cameras 108 can be directly ingested by the factory floor integration engine 132. The universal edge system 128 has the capability to fetch data that is available in various systems, including, but not limited to, the OPC UA server 122, historians, MES, SQL, IoT sensors and gateways, and the like, using different protocols such as MODBUS, PROFINET, and so forth.

The OT data from the factory floor integration engine 132 can be transmitted to the analytics service 138 of a custom solution in the custom application system 136, with the help of the lightweight messaging infrastructure available on the universal edge system 128. Preprocessing is enabled in the universal edge system 128 to eliminate bad data and contextualize data that is required for the analytics service 138. For example, images captured by a camera 108 are tagged with information captured from the MES 126 or OPC UA server 122. During preprocessing the universal edge system 128 can further determine actuation decisions which are then passed to the factory floor integration engine 132 via the Pub/Sub component 130 messaging service. The actuation decision is transmitted through the factory floor integration engine 132 to the OPC UA server 122 and then to the PLC data concentrator 120 which command the corresponding actuator. The analytics service 138 of the custom application system 136 can also decide to stream the data or send the data in batch format for machine learning model retraining, as explained in further detail below. The streaming data can be transmitted to the streaming component 158 of the cloud computing system 104 or to any third-party platform, including a third-party application/SAAS 188.

The analytics service 138 can transmit any events via the API management 148 to the MES system 126. The analytics service 138 can transmit data to the anomaly detection service 140 to determine the health and success ratio of one or more machine learning models running on the universal edge system 128. The anomaly detection service 140 can transmit data to the edge mounted PVC store 144 for retraining which is in turn transmitted to the cloud computing system 104. This data (such as images) can be first be compressed via a compression function so that the network bandwidth can be optimized. In some examples, the data can be optimized in size and include only the necessary amount required for retraining to improve the analytics model or service.

The manufacturing system 102 via the universal edge system 128 can communicate with the cloud computing system 104 shown in FIG. 1B. The cloud computing system 104 comprises various components such as the internet of things (IoT) processing and routing component 160 that can stream data to applications and third-party applications 162 via business logic 164, to notification service 166 for alerts via SMS, email, or other method, and to time series data storage 168. Alarms and events can also be sent via the data streaming component 142 to the messaging component 170. The cloud computing system 104 further comprises a container orchestration component 172 and a container registry component 174 as well as data storage 176 and consume 178 and analyze 180 components.

The cloud computing system 104 further comprises integration via an API hosting 182 and API management component 184. The cloud computing system 104 can include one or more custom application 162 comprising business logic 164 and data access 186 and one or more third-party application/SAAS 188. The cloud computing system 104 can be accesses by users such as data engineers 190, for example, through one or more user interfaces on one or more computing devices.

In the event of loss of connectivity to the cloud computing system 104, the universal edge system 128 can store data locally for a set duration for each application depending on criticality and resume forwarding the data as soon as the connectivity is back online. Further, in the event of loss of connectivity to the cloud computing system 104, the universal edge system 128 can scale up application workloads based on need. For example, if excess data is being processed from the sensors and the application workloads need additional compute to process the data spike, more compute resources can be allocated in order to process and make a decision in real time or near real time.

### Manufacturing System Processes

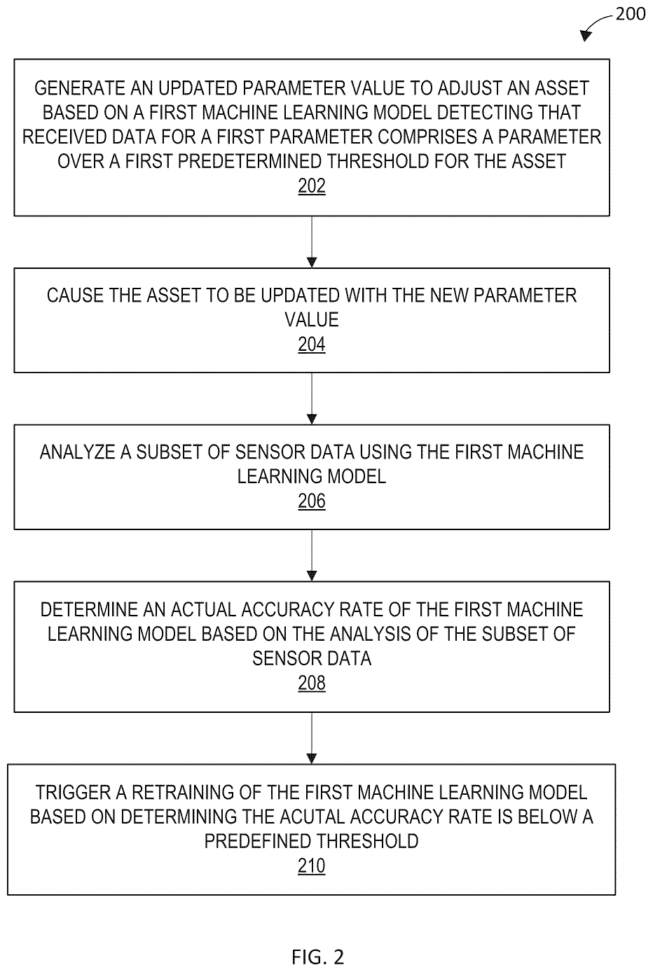

FIG. 2 is a flow chart illustrating aspects of a method 200, according to some example embodiments. For illustrative purposes, method 200 is described with respect to the block diagrams of FIGS. 1A and 1B. It is to be understood that method 200 can be practiced with other system configurations in other embodiments.

In operation 202, a computing system, such as the universal edge system 128, generates an updated parameter value to adjust an asset based on a first machine learning model detecting that received data for a first parameter comprises a parameter that is over or under a first predetermined threshold for the asset. For example, the computing system receives data, in real time or near real time, from the plurality of assets (e.g., assets 106) in the manufacturing system. This data can include data from various sensors associated with each asset, a camera stream for each of one or more cameras, and the like. In one example, the data received from the plurality of assets is data from one or more sensors on each asset of the plurality of assets.

In some examples, the computing system processes the data received from the plurality of assets in the manufacturing system to generate contextualized data. In some examples, processing the data received from the plurality of assets in the manufacturing system to generate contextualized data comprises filtering data to remove fields and adding additional data for a given use case in the cloud computing system 104. The computing system sends the contextualized data to cloud computing system 104 for storage and other analysis and processes.

The computing system analyzes the data as it is received for any anomalies, such as whether any of the data indicates a value over or under a threshold value for a given parameter. For example, the computing system analyzes the data as it is received using a plurality of rules and a plurality of machine learning models. If any of the rules are triggered, or any of the machine learning models identify an issue, the computing system generates an alert to specify an issue detected by the rules or machine learning models. In some examples, a subset of the contextualized data corresponding to the data for the alert is sent to the cloud computing system in a different channel than the contextualized data. In addition to contextualized data, the computing system can aggregate the data and filter the data to avoid streaming data not required in the cloud.

In one example, the plurality of machine learning models comprise a first machine learning model configured to detect that a first parameter is over or under a first predetermined threshold for the asset. The computing system analyzes the received data using the first machine learning model to determine whether the first parameter is over or under the first predetermined threshold for the asset. Based on determining that data for a first parameter comprises a parameter over or under a first predetermined threshold for an asset, the computing system generates an updated parameter value to adjust the asset. For instance, the computing system can determine that potatoes are being peeled to the correct specifications, if the flavor added matches a recipe, an oil or cooking temperature, a speed or temperature of a given asset (e.g., if a conveyor speed is above or below the predetermine threshold), how much packaging is available for the product, if bottles are being properly sterilized (e.g., if the sterilant flow or temperature is below a certain rate indicating issues with disinfection or sterility), if a concentration of a sterilant for bottles is correct, if the air flow is adequate to dry bottles after they are rinsed, if bottles are being filled to a correct level, a sparging level for carbonated beverages, water and air flow rates, and so forth.

These assets can be adjusted immediately, in real time or near real time, to minimize waste, ensure minimal to no change in speed or production, and to avoid or minimize cutting off a particular production line. This is not possible to do in real time, or near real time, manually. Using a just a simple example, in the potato chip scenario, there are different sizes of potatoes, and, during the peeling process, it is not possible for a human operator to change the peeling level based on the dimensions of the potato which can change every few seconds. Instead, the computing system, based on rules and/or machine learning models, can analyze one or more camera streams to detect potato dimensions and automatically adjust the parameter to affect the change in peeling level, real time or near real time. The computing system can actuate the peelers to set the correct peeling level to avoid under peeling to comply with standards and ensure quality, or over peeling resulting in loss of pulp.

In operation 204, the computing system causes the asset associated with the data for the first parameter to be updated with the updated parameter value. For example, the computing system can send instructions with the updated parameter directly to a sensor controller on the asset (or via an OPC UA server 122 or PLC data concentrator 120) to cause the asset to be updated with the updated parameter value. In this way the computing system adjusts one or more parameters of asset.

To ensure that a machine learning model is continuing to perform at an acceptable level, the computing system regularly assesses each machine learning model. In operation 206, the computing system analyzes sensor data, such as a subset of a plurality of frames in a camera feed from a camera in the manufacturing system or other sensor data using the first machine learning model deployed on the manufacturing system. In the example of using data from a camera feed, for a high-definition video there may be more than 1000 frames per second, and the computing system will capture a subset, for example, one frame per second or other predetermined number frames per second or other time frame, to use to determine an accuracy of the first machine learning model deployed on the manufacturing system. Data analyzed can include any data received from sensors in the computing system, including text, image, video, and other data. The computing system uses a subset of this data to assess each machine learning model. In some examples, the subset of data is received in real time or near real time and analyzed in real time or near real time from receiving the data.

The first machine learning model analyzes the subset of the plurality of frames in the camera feed or other sensor data to generate an output. The first machine learning model is associated with a deployed accuracy rate that was determined when the first machine learning model was deployed on the manufacturing system based on benchmarking done before deployment.

The computing system determines an actual accuracy rate of the first machine learning model based on an output by the first machine learning model from analysis of the plurality of frames in the camera feed, as shown in operation 208. For example, the first machine learning model can also be termed as a base model. The output of the base model, which includes the inference results on the video or data stream, is calculated. In addition to the inference results, the model provides a confidence score for each prediction, indicating the confidence level of the model's perception of the data. This confidence score reflects the model's accuracy during inference. Over a specified time, window, the computing system compares this score with the desired threshold. If a decline in the score is observed over time, the computing system flags it as a model or data drift detection. The computing system then determines whether the actual accuracy rate is below a predefined threshold corresponding to the deployed accuracy rate. For example, the predefined threshold can be the deployed accuracy rate, a percentage value below the deployed accuracy rate, or other value.

In operation 210, the computing system determines that the actual accuracy rate is below the predefined threshold corresponding to the deployed accuracy rate. Based on determining that the actual accuracy rate is below the predefined threshold corresponding to the deployed accuracy rate, the computing system triggers a retraining of the first machine learning model using at least the subset of the plurality of frames in the camera feed or other sensor data as training data that was used to detect that the actual accuracy rate is below the deployed or desired accuracy rate. For instance, the computing system captures at least those frames where the accuracy dropped below the predefined threshold and uses those (e.g., 10 frames or other configurable number) or other sensor data as part of the training data to retrain the machine learning model until it reaches the desired accuracy rate or other specified metric. In some examples, the computing system determines whether the machine learning model is one with critical operations or non-critical operations. If the machine learning model is one with critical operations, the computing system immediately alerts that retraining is needed which results in the machine learning model retraining and then redeployment. If the machine learning model is one with non-critical operations, the trigger can indicate that the machine learning model can be retrained at a periodic level with the new data.

In some examples, retraining of the first machine learning model is done on the cloud computing system 104. Accordingly, the computing system sends the trigger for retraining and the frames where the accuracy dopped, to the cloud computing system 104 to retrain the first machine learning model. Once the first machine learning model is retrained by the cloud computing system 104, the retrained first machine learning model is deployed on the manufacturing system to replace the first machine learning model.

In some examples, the computing system generates a hierarchy of assets in the manufacturing system, such as via the asset auto discover component 134. For example, the computing system can scan all the assets, sensors and gateways available on the wired or wireless network as well as the assets tags captured from the OPC UA server 122 and historian servers and group the assets intelligently to form a logical hierarchy based on a naming convention and previously trained pattern to identify a parent and child relationship between assets. The hierarchy can show multiple floors, lines, multiple assets, precedence or order of the assets, and so forth. As an example, the hierarchy can have a first level with the floor plan of the manufacturing environment, a second level with a particular area within the manufacturing, and third level with equipment or assets, a fourth level with subsystem of the equipment or assets, and a fifth level with sensor deployed on the equipment or assets. It is to be understood that more, less, or different levels can be used in examples described herein. In some examples, the hierarchy is maintained in a graph database in the computing system and/or cloud computing system and a last known state can be associated with each asset to show a current and desired status to help operators know exact line status and overall plant status.

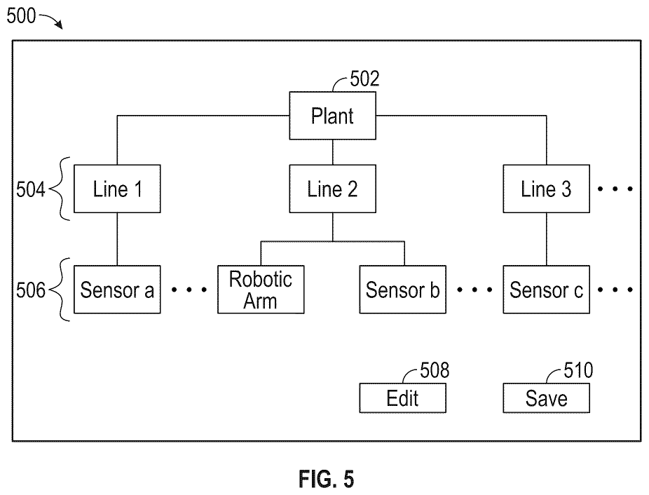

FIG. 5 illustrates an example user interface 500 showing a simple example of a hierarchy that has been generated that includes a first level 502, a second level 504 and a third level 506. The example user interface 500 includes a visualization of the assets that can be modified by a user if needed, such a via an edit option 508. The example user interface 500 also allows a user to view orphan assets and update the hierarchy to send feedback to the graph database. The example user interface 500 further provides the ability for a user to send a command or feedback to override any current status to maintain the desired status of a manufacturing line and save 510 the hierarchy including any edits made.

This hierarchy can be used for, among other things, determining whether updating an asset with an updated parameter value will also necessitate a change to other assets upstream or downstream from the asset. Accordingly, before causing the asset associated with the data for the first parameter to be updated with the updated parameter value, the computing system can analyze other assets in a hierarchy of assets in the manufacturing system to determine a at least a second parameter on at least a second asset to be updated based on the first parameter being updated and cause the at least the second asset to be updated with a second updated parameter value. For example, the updated parameter value may be a speed of a conveyor belt and adjusting the speed of the conveyor belt can affect the speed of the robotic arm operating on products on the conveyor belt. Thus, the computing system would also determine how the speed of the robotic arms needs to be updated.

The computing system can further scan the manufacturing system to detect, in real time or near real time, any new assets and, based on detecting a new asset, add the new asset to the hierarchy of assets in the manufacturing system. Often assets or sensors are added to the manufacturing system and since can be very large and comprise many assets and sensors, there is no way to manually be sure that all assets are accounted for otherwise, and thus, valuable data from these unaccounted-for assets are not received or analyzed. By periodically scanning the manufacturing system, the computing system can ensure all assets are accounted for.

In some examples, instead of, or in addition to, automatically causing an asset to be updated with an updated parameter value the computing system can generate an alert to be displayed on a user interface on a computing device in the manufacturing system, such as on HMI 116. For example, based on determining that data for a third parameter comprises a parameter over or under a third predetermined threshold for a third asset, the computing system can generate an updated parameter value to adjust the third asset and cause display of an alert on a user interface on a computing device in the manufacturing system indicating that the third parameter is over or under the third predetermine threshold.

Accordingly, the manufacturing system described herein can continuously receive data from sensors and, using that system, automatically optimize various parameters in the system. Using a specific example of a manufacturing system to make potato chips, the manufacturing system is continuously receiving and processing data on numerous parameters, including, but not limited to, the seed that was used to grow the potatoes in the system, the farm the potatoes were grown in, weather conditions of the farm, the characteristics of the potatoes (e.g., weight, firmness, shape, taste, peel characteristics, starch compound composition, color, digestibility), cooking temperatures (e.g., to be sure not overcooked or undercooked and to ensure the right level of crispiness), ability to withstand breakage and remain intact, price, energy required to produce the given potato, price of processing the given potato, optimal growth conditions for the given potato, where the potato can be most efficiently grown (e.g., lowest environmental impact, lowest water consumption and waste, lowest price), where chips produced for the given potato are most popular (e.g., measured by sales data), and the like.

Using another specific example of a manufacturing system to make beverages, the manufacturing system is continuously receiving and processing data on numerous parameters including, but not limited to, types of packaging (e.g., container type, such as a bottle, can, jug, or container composition, such as plastic, fiber, glass, metal, composite/combination), line speed (e.g., rate at which bottles are sterilized, rate at which bottles are filled, rate at which bottles are capped), type of sterilant, processing temperatures for sanitizer or sterilant (e.g., to ensure warm enough to property clean/sanitize/sterilize without deforming the bottle), air rinse temperature, water rinse temperature, beverage processing temperature, pH, hot fill versus cold fill, density of product, and so forth.

The above-mentioned data comprise some examples for training parameters that can be used for one or more machine learning models and can be controlled by the computing system for real time optimization, alarming, and monitoring. The parameters and are similarly determined for other food and beverage products, such as chickpeas, corn, tubers, roots, legumes, carbonated beverages, non-carbonated beverages, high acid beverages, low acid beverages, hot fill, cold fill, and so forth.

### Machine Architecture

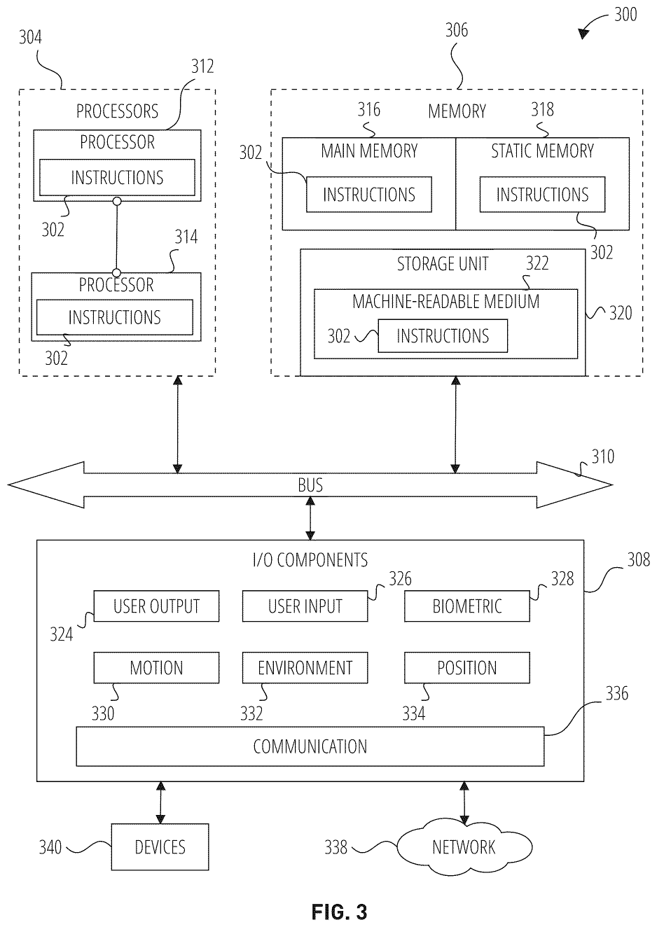

FIG. 3 is a diagrammatic representation of the machine 300 within which instructions 302 (e.g., software, a program, an application, an applet, an app, or other executable code) for causing the machine 300 to perform any one or more of the methodologies discussed herein may be executed. For example, the instructions 302 may cause the machine 300 to execute any one or more of the methods described herein. The instructions 302 transform the general, non-programmed machine 300 into a particular machine 300 programmed to carry out the described and illustrated functions in the manner described. The machine 300 may operate as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, an asset in an manufacturing system, or any machine capable of executing the instructions 302, sequentially or otherwise, that specify actions to be taken by the machine 300. Further, while a single machine 300 is illustrated, the term “machine” shall also be taken to include a collection of machines that individually or jointly execute the instructions 302 to perform any one or more of the methodologies discussed herein. The machine 300, for example, may comprise an asset 106 or any one of multiple server devices forming part of the manufacturing system 102 or cloud computing system 104. In some examples, the machine 300 may also comprise both client and server systems, with certain operations of a particular method or algorithm being performed on the server-side and with certain operations of the method or algorithm being performed on the client-side.

The machine 300 may include processors 304, memory 306, and input/output I/O components 308, which may be configured to communicate with each other via a bus 310.

The memory 306 includes a main memory 316, a static memory 318, and a storage unit 320, both accessible to the processors 304 via the bus 310. The main memory 306, the static memory 318, and storage unit 320 store the instructions 302 embodying any one or more of the methodologies or functions described herein. The instructions 302 may also reside, completely or partially, within the main memory 316, within the static memory 318, within machine-readable medium 322 within the storage unit 320, within at least one of the processors 304 (e.g., within the processor's cache memory), or any suitable combination thereof, during execution thereof by the machine 300.

The I/O components 308 may include a wide variety of components to receive input, provide output, produce output, transmit information, exchange information, capture measurements, and so on. The specific I/O components 308 that are included in a particular machine will depend on the type of machine. For example, portable machines such as mobile phones may include a touch input device or other such input mechanisms, while a headless server machine will likely not include such a touch input device. It will be appreciated that the I/O components 308 may include many other components that are not shown in FIG. 3. In various examples, the I/O components 308 may include user output components 324 and user input components 326. The user output components 324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 330 include acceleration sensor components (e.g., accelerometer), gravitation sensor components, rotation sensor components (e.g., gyroscope).

The environmental components 332 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

Communication may be implemented using a wide variety of technologies. The I/O components 308 further include communication components 336 operable to couple the machine 300 to a network 338 or devices 340 via respective coupling or connections. For example, the communication components 336 may include a network interface component or another suitable device to interface with the network 338. In further examples, the communication components 336 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 340 may be another machine or any of a wide variety of peripheral devices (e.g., a peripheral device coupled via a USB).

Moreover, the communication components 336 may detect identifiers or include components operable to detect identifiers. For example, the communication components 336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 336, such as location via Internet Protocol (IP) geolocation, location via Wi-Fi® signal triangulation, location via detecting an NFC beacon signal that may indicate a particular location, and so forth.

The various memories (e.g., main memory 316, static memory 318, and memory of the processors 304) and storage unit 320 may store one or more sets of instructions and data structures (e.g., software) embodying or used by any one or more of the methodologies or functions described herein. These instructions (e.g., the instructions 302), when executed by processors 304, cause various operations to implement the disclosed examples.

The instructions 302 may be transmitted or received over the network 338, using a transmission medium, via a network interface device (e.g., a network interface component included in the communication components 336) and using any one of several well-known transfer protocols (e.g., hypertext transfer protocol (HTTP)). Similarly, the instructions 302 may be transmitted or received using a transmission medium via a coupling (e.g., a peer-to-peer coupling) to the devices 340.

### Software Architecture

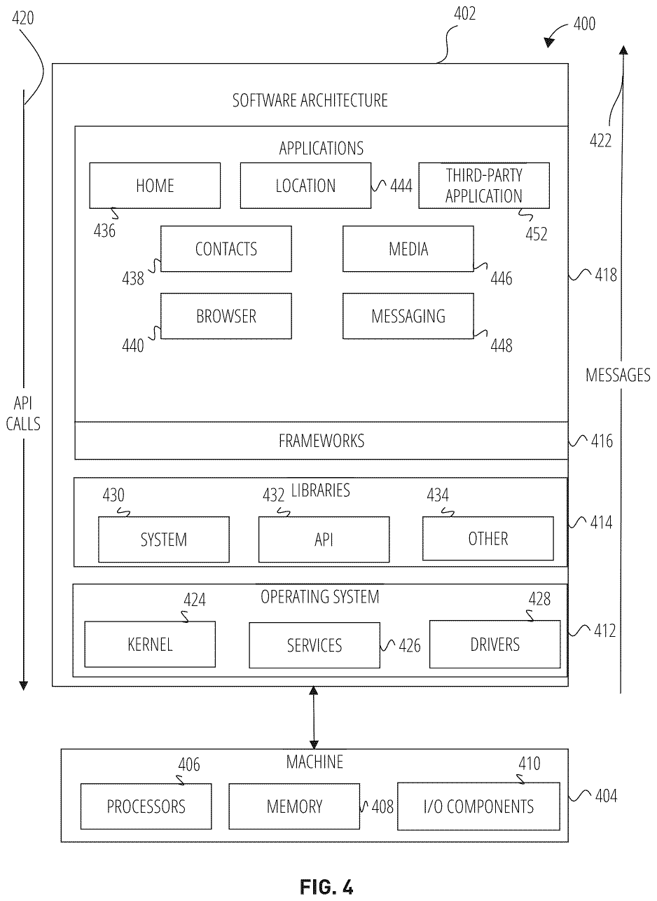

FIG. 4 is a block diagram 400 illustrating a software architecture 402, which can be installed on any one or more of the devices described herein. The software architecture 402 is supported by hardware such as a machine 404 that includes processors 406, memory 408, and I/O components 410. In this example, the software architecture 402 can be conceptualized as a stack of layers, where each layer provides a particular functionality. The software architecture 402 includes layers such as an operating system 412, libraries 414, frameworks 416, and applications 418. Operationally, the applications 418 invoke API calls 420 through the software stack and receive messages 422 in response to the API calls 420.

The operating system 412 manages hardware resources and provides common services. The operating system 412 includes, for example, a kernel 424, services 426, and drivers 428. The kernel 424 acts as an abstraction layer between the hardware and the other software layers. For example, the kernel 424 provides memory management, processor management (e.g., scheduling), component management, networking, and security settings, among other functionalities. The services 426 can provide other common services for the other software layers. The drivers 428 are responsible for controlling or interfacing with the underlying hardware. For instance, the drivers 428 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 414 provide a common low-level infrastructure used by the applications 418. The libraries 414 can include system libraries 430 (e.g., C standard library) that provide functions such as memory allocation functions, string manipulation functions, mathematical functions, and the like. In addition, the libraries 414 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 414 can also include a wide variety of other libraries 434 to provide many other APIs to the applications 418.

The frameworks 416 provide a common high-level infrastructure that is used by the applications 418. For example, the frameworks 416 provide various graphical user interface (GUI) functions, high-level resource management, and high-level location services. The frameworks 416 can provide a broad spectrum of other APIs that can be used by the applications 418, some of which may be specific to a particular operating system or platform.

In an example, the applications 418 may include a home application 436, a contacts application 438, a browser application 440, an asset management application 442, a location application 444, a media application 446, a messaging application 448, and a broad assortment of other applications such as a third-party application 452. The applications 418 are programs that execute functions defined in the programs. Various programming languages can be employed to create one or more of the applications 418, structured in a variety of manners, such as object-oriented programming languages (e.g., Objective-C, Java, or C++) or procedural programming languages (e.g., C or assembly language). In a specific example, the third-party application 452 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 452 can invoke the API calls 420 provided by the operating system 412 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, network attached storage (NAS), storage area networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A computer-implemented method comprising:
receiving data in real time from a plurality of assets in a manufacturing system;
analyzing the data as it is received to determine whether any of the data indicates a value over or under a threshold value for a given parameter;
based on determining that data for a first parameter comprises a parameter over or under a first predetermined threshold for an asset, generating an updated parameter value to adjust the asset, the determining that the data for the first parameter comprises a parameter over or under a first predetermined threshold for an asset being performed by a first machine learning model deployed on the manufacturing system;
causing the asset associated with the data for the first parameter to be updated with the updated parameter value;
analyzing a subset of sensor data in the manufacturing system using the first machine learning model deployed on the manufacturing system, the first machine learning model associated with a deployed accuracy rate;
determining an actual accuracy rate of the first machine learning model based on an output by the first machine learning model from analysis of the subset of sensor data;
determining whether the actual accuracy rate is below a predefined threshold corresponding to the deployed accuracy rate; and
based on determining that the actual accuracy rate is below the predefined threshold corresponding to the deployed accuracy rate, triggering a retraining of the first machine learning model using at least the subset of sensor data as training data.

2. The computer-implemented method of claim 1, wherein the subset of sensor data is a subset of a plurality of frames in a camera feed.

3. The computer-implemented method of claim 1, wherein the data is analyzed as it is received using a plurality of rules and a plurality of machine learning models, the plurality of machine learning models including the first machine learning model.

4. The computer-implemented method of claim 1, further comprising:
deploying the retrained first machine learning model on the manufacturing system to replace the first machine learning model.

5. The computer-implemented method of claim 1, wherein before causing the asset associated with the data for the first parameter to be updated with the updated parameter value, the method comprises:
analyzing other assets in a hierarchy of assets in the manufacturing system to determine a second parameter on at least a second asset to be updated based on the first parameter being updated; and
causing the at least the second asset to be updated with a second updated parameter value.

6. The computer-implemented method of claim 5, further comprising:
scanning the manufacturing system to detect a new asset; and
adding the new asset to the hierarchy of assets in the manufacturing system.

7. The computer-implemented method of claim 1, wherein the data received from the plurality of assets is data from one or more sensors on each asset of the plurality of assets.

8. The computer-implemented method of claim 1, further comprising:
processing the data received from the plurality of assets in the manufacturing system to generate contextualized data; and
sending the contextualized data to a cloud computing system.

9. The computer-implemented method of claim 8, further comprising:
sending a subset of the contextualized data corresponding to the data for the first parameter to the cloud computing system in a different channel than the contextualized data.

10. The computer-implemented method of claim 1, wherein processing the data received from the plurality of assets in the manufacturing system to generate contextualized data comprises filtering data to remove fields and adding additional data for a given use case in a cloud computing system.

11. The computer-implemented method of claim 1, further comprising:
wherein based on determining that data for a third parameter comprises a parameter over or under a third predetermined threshold for a third asset, generating an updated parameter value to adjust the third asset; and
causing display of an alert on a user interface on a computing device in the manufacturing system indicating that the third parameter is over or under the third predetermined threshold.

12. The computer-implemented method of claim 1, further comprising:
wherein based on determining that data for a third parameter comprises a parameter over or below a third predetermined threshold for a third asset, generating an updated parameter value to adjust the third asset; and
causing an optimization of the manufacturing system.

13. A system comprising:
at least one processor;
at least one memory component storing instructions that, when executed by the at least one processor, cause the at least one processor to perform operations comprising:
receiving data in real time from a plurality of assets in a manufacturing system;
analyzing the data as it is received to determine whether any of the data indicates a value over or under a threshold value for a given parameter;
based on determining that data for a first parameter comprises a parameter over or under a first predetermined threshold for an asset, generating an updated parameter value to adjust the asset, the determining that the data for the first parameter comprises a parameter over or under a first predetermined threshold for an asset being performed by a first machine learning model deployed on the manufacturing system;
causing the asset associated with the data for the first parameter to be updated with the updated parameter value;
analyzing a subset of sensor data in the manufacturing system using the first machine learning model deployed on the manufacturing system, the first machine learning model associated with a deployed accuracy rate;
determining an actual accuracy rate of the first machine learning model based on an output by the first machine learning model from analysis of the subset of sensor data;
determining whether the actual accuracy rate is below a predefined threshold corresponding to the deployed accuracy rate; and
based on determining that the actual accuracy rate is below the predefined threshold corresponding to the deployed accuracy rate, triggering a retraining of the first machine learning model using at least the subset of sensor data as training data.

14. The system of claim 13, wherein the data is analyzed as it is received using a plurality of rules and a plurality of machine learning models, the plurality of machine learning models including the first machine learning model.

15. The system of claim 13, the operations further comprising:
deploying the retrained first machine learning model on the manufacturing system to replace the first machine learning model.

16. The system of claim 13, wherein before causing the asset associated with the data for the first parameter to be updated with the updated parameter value, the operations comprise:
analyzing other assets in a hierarchy of assets in the manufacturing system to determine a second parameter on at least a second asset to be updated based on the first parameter being updated; and
causing the at least the second asset to be updated with a second updated parameter value.

17. The system of claim 16, the operations further comprising:
scanning the manufacturing system to detect a new asset; and
adding the new asset to the hierarchy of assets in the manufacturing system.

18. The system of claim 13, wherein the data received from the plurality of assets is data from one or more sensors on each asset of the plurality of assets.

19. The system of claim 13, the operations further comprising:
processing the data received from the plurality of assets in the manufacturing system to generate contextualized data;
sending the contextualized data to a cloud computing system; and
sending a subset of the contextualized data corresponding to the data for the first parameter to the cloud computing system in a different channel than the contextualized data.

20. A non-transitory computer-readable storage medium storing instructions that, when executed by at least one processor, cause the at least one processor to perform operations comprising:
receiving data in real time from a plurality of assets in a manufacturing system;
analyzing the data as it is received to determine whether any of the data indicates a value over or under a threshold value for a given parameter;
based on determining that data for a first parameter comprises a parameter over or under a first predetermined threshold for an asset, generating an updated parameter value to adjust the asset, the determining that the data for the first parameter comprises a parameter over or under a first predetermined threshold for an asset being performed by a first machine learning model deployed on the manufacturing system;
causing the asset associated with the data for the first parameter to be updated with the updated parameter value;
analyzing a subset of sensor data in the manufacturing system using the first machine learning model deployed on the manufacturing system, the first machine learning model associated with a deployed accuracy rate;
determining an actual accuracy rate of the first machine learning model based on an output by the first machine learning model from analysis of the subset of sensor data;
determining whether the actual accuracy rate is below a predefined threshold corresponding to the deployed accuracy rate; and
based on determining that the actual accuracy rate is below the predefined threshold corresponding to the deployed accuracy rate, triggering a retraining of the first machine learning model using at least the subset of sensor data as training data.
